(19) United States
(12) Patent Application Publication
(10) Pub. No.: US 2010/0282330 A1
(43) Pub. Date: Nov. 11, 2010

(54) BURST PLUG

(76) Inventors: Kenneth M. Luther, Toledo, OH (US); Donald J. Gembolis, Toledo, OH (US)

Correspondence Address: CHRISTOPHER H. HUNTER, PARKER-HANFIN CORPORATION, 6035 PARKLAND BOULEVARD, CLEVELAND, OH, 44124-4141, US

(21) Appl. No.: 12/773,434

(22) Filed: May 4, 2010

Related U.S. Application Data
(60) Provisional application No. 61/175,559, filed on May 5, 2009.

(51) Int. Cl. F16K 17/40

(52) U.S. Cl. 137/68.11

(57) ABSTRACT

A plug for a fluid system includes an externally-threaded body and an enlarged head at an end of the body. The body has an internal cavity with a) a first fluid passage into the cavity from another end of the body, and b) at least one radial or axial relief passage into the cavity fluidly separate from the first passage. A burst piston is retained within the cavity and normally blocks fluid flow from the first passage to the relief passage. The piston has a geometry such that a portion of the piston will rupture and separate from the remainder of the piston at a predetermined pressure differential across the first and relief passages, and allow fluid to flow from the first passage to the relief passage. The relief passage has a geometry to prevent the separated portion of the piston from passing through the relief passage.

### CROSS REFERENCE TO RELATED APPLICATIONS

The present application claims the benefit of the filing date of U.S. Provisional application Ser. No. 61/175,559, filed May 5, 2009, the disclosure of which is incorporated herein by reference in its entirety.

### FIELD OF THE INVENTION

The present invention relates generally to overpressure relief devices in fluid systems, which relieve fluid when the pressure in the system exceeds a predetermined level.

### BACKGROUND OF THE INVENTION

Relief valves and rupture disks are known in the fluid industry to provide a relief passage to prevent over-pressure in a system from causing catastrophic failure of the system, e.g., rupturing a containment vessel in the system. Relief valves and rupture discs are independent components that must be specified, purchased, and installed in the system. In most cases, their installation requires additional devices, plumbing, etc. These devices can also require proper set points to be safe, and must be inspected and maintained regularly. Rupture discs can be expensive and may produce shrapnel upon burst.

Threaded plugs and connectors for fluid systems are also known which include a relatively thin end cap or cover, and a body with an annular side wall which is internally and/or externally threaded. The body is received within or threaded down onto a cooperating threaded component of the fluid system in order to prevent flow through an opening or port. U.S. Pat. Nos. 4,342,337 and 5,452,748 show and describe example of such plugs and connectors. It is also known from U.S. Pat. No. 6,810,915 to provide a weakened portion comprising a circular recess in the sidewall of a safety valve, where the weakened portion is designed to break to release gas under pressure into an oil pressure circuit to avoid rupture of a pressure vessel.

### SUMMARY OF THE INVENTION

According to one aspect of the invention, a plug device is provided with a defined shear area that ruptures and separates from the remainder of the plug at a predetermined pressure to relieve internal pressure in a fluid system. Pressure relief passage(s) in the plug have a geometry that retains the shear portion within the plug after separation.

A piston can be provided internal to the plug and includes an end wall with the shear portion. The shear portion can be formed such as by the geometry of the wall (e.g., a relatively thin portion), and/or by a feature such as a score line. The piston can be mechanically retained within an internal cavity of the plug, and an O-seal can be provided between the piston and plug body to provide a fluid-tight seal. The relief passage(s) in the plug can have a geometry, e.g., an axial or radial passage intersecting a main cavity at an angle or offset from a central axis, and/or set dimensions smaller than the shear portion to prevent the shear portion from exiting to the external environment. Fluid internal to the plug is allowed to flow out through the relief passage(s) when the shear portion ruptures, thus relieving the internal pressure and preventing catastrophic failure of the system.

The plug device of the present invention is simple, relatively inexpensive, and contains no moving parts. The device can be similar in appearance to a standard pipe fitting. Further features and advantages should be apparent to those of ordinary skill in the art upon reviewing the following drawings and detailed description.

### BRIEF DESCRIPTION OF THE DRAWINGS

FIG. 1 is an elevated perspective view, in cross-section, of a plug constructed according a first embodiment of the present invention;

FIG. 2 is a top view of the plug of FIG. 1, shown installed within a product;

FIG. 3 is a bottom end view of the plug of FIG. 2;

FIG. 4 is a cross-sectional view of the plug and product, taken along the plane described by the lines 4-4 of FIG. 2;

FIG. 5 is an elevated perspective view similar to FIG. 1, illustrating the plug after it has burst;

FIG. 6 is an elevated perspective view, in cross-section, of a plug constructed according to a second embodiment of the present invention; and

FIG. 7 is an elevated perspective view similar to FIG. 6, illustrating the plug after it has burst.

### DETAILED DESCRIPTION OF THE PROFFERED EMBODIMENT

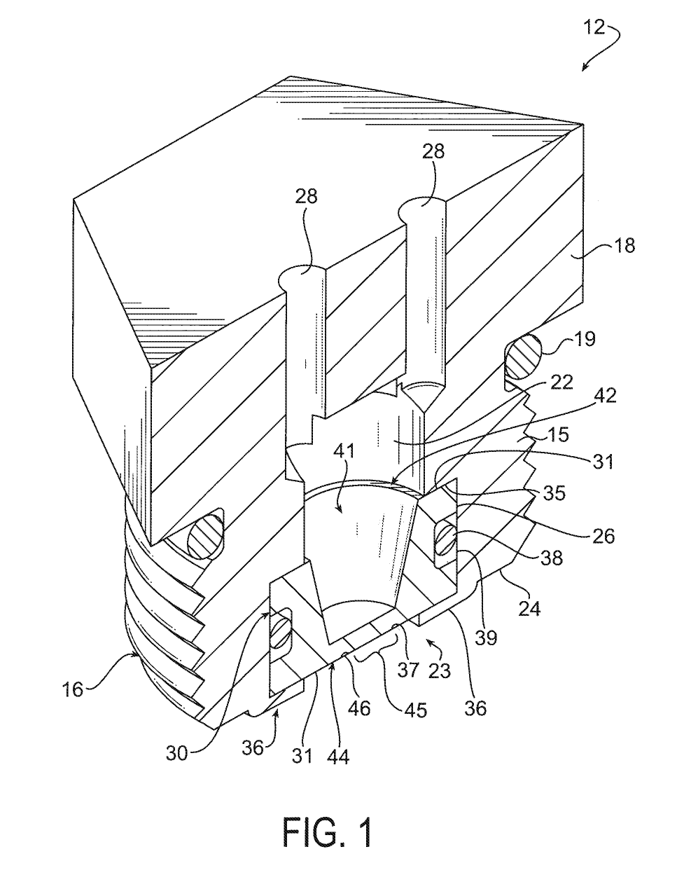

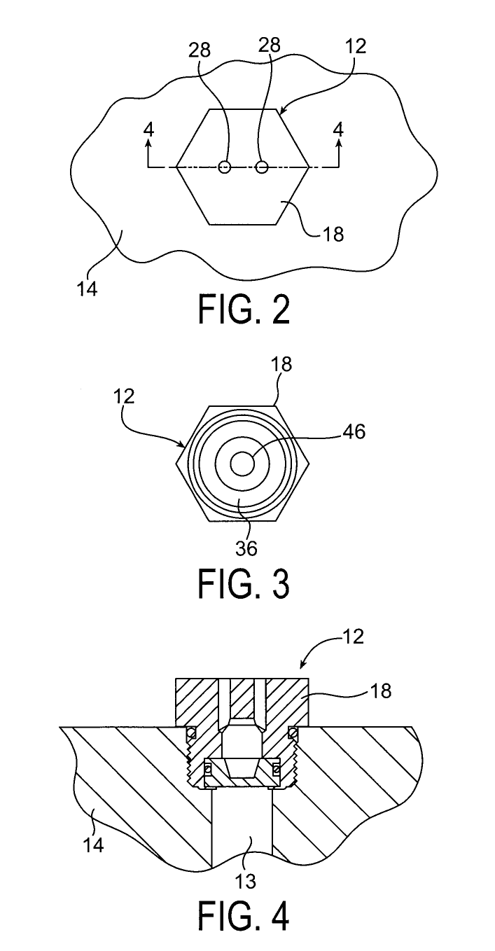

Referring to the drawings, and initially to FIGS. 1-4, a plug device is shown generally at 12, constructed according to the principles of the present invention.

The plug (also referred to as a “fitting” or “connection”) can be directly installed into a port 13 of a product, indicated generally at 14 (e.g., a filter, pump, manifold block, etc) as should be appreciated by those skilled in the art. The port 13 can betheraded or have other means for retaining the plug. The plug encloses the port 13 and normally prevents fluid leakage therefrom.

The plug 12 includes an annular body 15 which is externally threaded as at 16; and a flat head 18 at its top which is preferably enlarged and includes appropriate geometry (such as the illustrated peripheral hex geometry) as is typical for such a plug to allow the head to be manipulated by a tool such as a wrench, to screw the plug into and out of the threaded port 13. An O-ring seal 19 can be provided, if necessary or appropriate, along the exterior annular wall of the plug, between the threads 16 and the head 18, to provide a fluid-tight seal between the plug and the product 14.

The annular body 15 of the plug includes an internal cylindrical main cavity as at 22 with an opening, indicated generally at 23, at the bottom distal end 24 of the plug. The main cacvity has an enlarged cavity portion 26 adjacent the distal end of the plug. As shown in FIG. 1, one and preferably two or more relief passages, as at 28, are formed in the head 18 of the plug, and fluidly interconnect the main cavity 22 through the top of the plug with the external environment. Passages 28 can extend axially, as shown, and interconnect with the main cavity 22 at or toward the periphery of the cavity.

The plug body 15 and head 18 can be formed from e.g., metal or other appropriate material, using common manufacturing techniques, such as mechanical machining and drilling, which should also be apparent to those skilled in the art. The body and head are preferably formed unitary (in one piece) with each other; however they could also be formed in two or more pieces and fixed together in an appropriate manner, such as by brazing, forming, etc.

A piston, indicated generally at 30, is received internally of the body cavity 22. Piston 30 has a body 31 with an annular configuration, and is closely and completely received within the enlarged portion 26 of the cavity; and in particular, the piston has an internal annular end surface 32 which sits flush against an internal radial shoulder 35 formed between the enlarged cavity portion 26 and the upper/outer portion of the main cavity 22. A portion of the body end, indicated generally at 36, surrounding the opening 23 to the cavity, can be formed such as by swaging or other machining techniques, against the outer end wall surface 37 of the piston, to fixedly retain the piston within the cavity. Alternatively, the piston could be fixedly retained via other techniques or devices, e.g., threads, adhesive, friction fit, etc., within the cavity. An O-ring seal as at 38, can be provided if necessary or desirable, in an annular channel 39 extending around the periphery of the piston body and provide a fluid tight seal between the outer wall of the piston and an inner wall of the plug body defining the enlarged cavity portion 26.

The piston 30 has an internal tapered wall 41 defining a frustroconical cavity, with an open end, indicated generally at 42, facing the main cavity 22 and the relief passage(s) 28; and a closed end, indicated generally at 44 defined by end wall 37.

The end wall 37 of the piston has a shear portion which ruptures and separates from the remainder of the piston when a predetermined pressure differential exists across the piston, such as during an over-pressure situation within the product. To this end, a central, shear portion, indicated generally at 45, of the end wall can have a relatively thinner dimension than the surrounding portion of the piston, or can have some other geometry, such that a defined portion of the end wall can rupture and separate at a predetermined pressure differential. The geometry and dimensions of the shear portion and the remainder of the end wall 37 can vary depending upon the particular application and desired rupture pressure, and can be determined by simple experimentation. Alternatively or in addition to the geometry, a feature such as an annular score line as shown at 46, or other weakened section, can be formed in the outer surface of the end wall 37 and define the shear area. Score line 46 can facilitate ensuring that a specific and defined portion of the end wall fully ruptures and separates from the remainder of the end wall during an over-pressure situation.

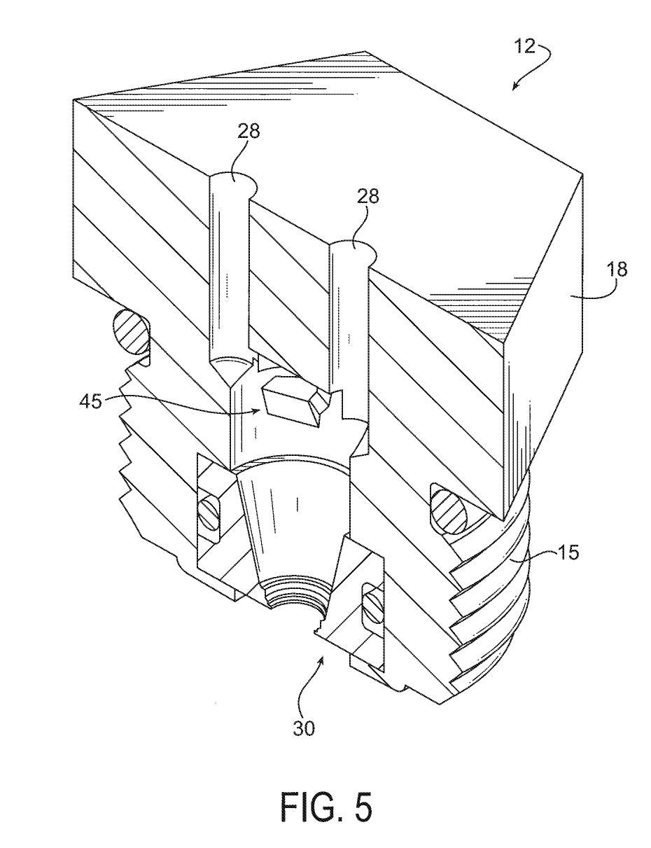

When the plug 12 is installed within the product, as shown in FIG. 4 for example, the plug functions as any normal plug in the situation, and prevents fluid from exiting port 13 during normal operation. When an overpressure condition exists, the defined shear portion 45 of the piston ruptures and separates, as shown in FIG. 5, and is blown outwardly, away from the piston. In FIG. 5 the defined shear portion of the end wall can be clearly seen, defining a circular opening for fluid flow out through the plug. The geometry of the relief passages, e.g., the size difference and/or the offset/labyrinth passages, retains the shear portion 45 within the main cavity 22 of the piston, and prevents the shear portion from exiting the plug. Nonetheless, fluid within the system can flow out through the relief passages(s) and relieve some of the over-pressure situation within the fluid system, to prevent catastrophic failure of the product. Of course, properly numbering and sizing the relief passages 28 and sizing the shear portion 45 can be important to enable sufficient relief fluid flow to resolve the overpressure situation, as should be appreciated by those skilled in the art. The relatively small geometry of the relief passages will mostly just allow a “weep” of the fluid—to enable rapid discovery and correction of the overpressure situation without significant fluid leakage, but still reducing the chance of catastrophic failure of the system.

While the foregoing describes an assembly of a plug and piston, it is possible the pressent invention could alternatively be expressed as a one-piece plug, where an internal wall (such as wall 37 in the aforementioend piston) would be formed integral with the body of the plug, rather than with a piston, and include the geometry or feature defining a shear portion. Thus, in a broad sense, it should be appreciated that the present invention is not limited to a plug of any particular number of components, or shape, size or geometry.

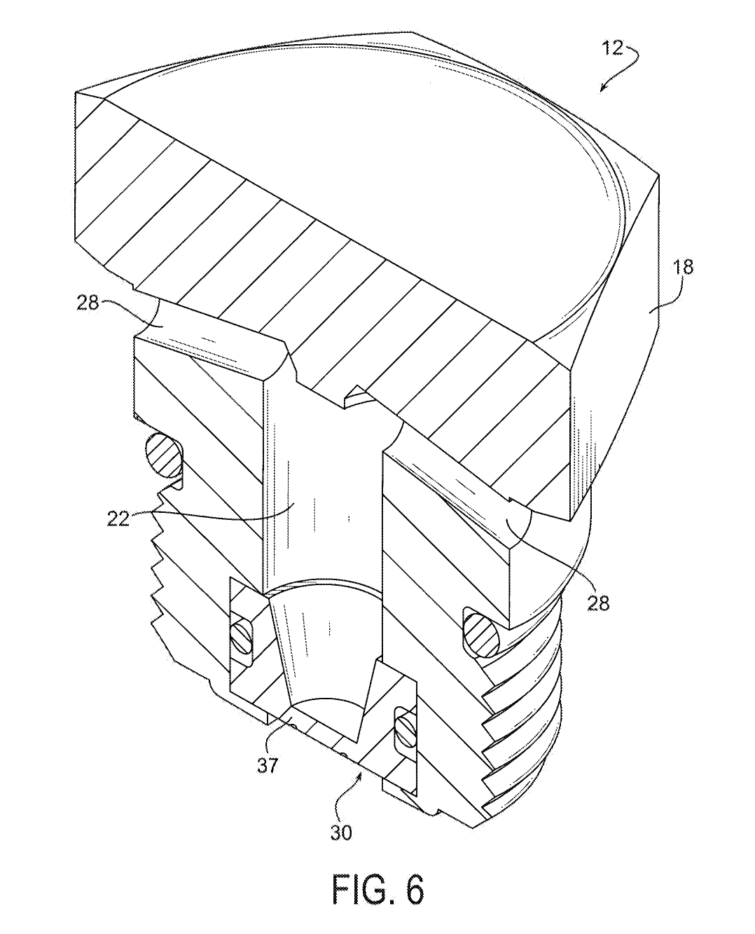

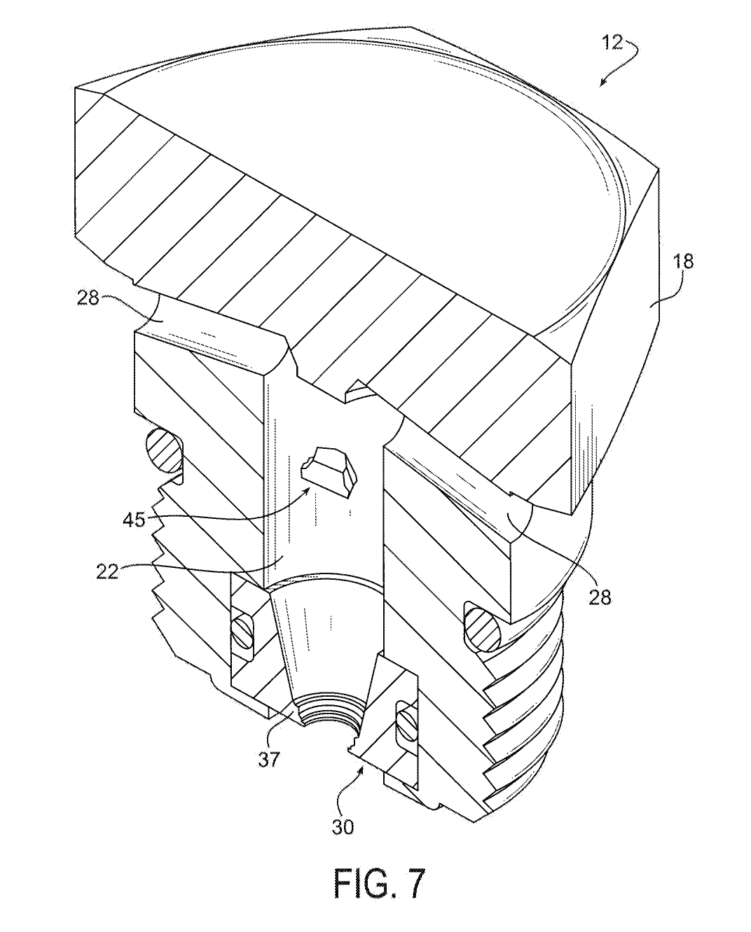

Referring now to FIGS. 6 and 7, an alternative embodiment of the plug 12 of the present invention is shown. In these figures, plug 12 is substantially the same as in FIGS. 1-5, but the relief passages 28 are shown formed radially through the plug, toward the inner/lower end of the head 18, rather than axially through the head. Passages 28 radially intersect the main cavity 22 and again, provide a labyrinth circuit or otherwise have a geometry to prevent the shear portion 45 (FIG. 7) from exiting the plug after the end wall 37 has ruptured.

The remainder of the plug 12 shown in FIGS. 6 and 7 is the same as in FIGS. 1-5, and will not be described further for sake of brevity.

The principles, preferred embodiments and modes of operation of the present invention have been described in the foregoing specification. The invention which is intended to be protected herein should not, however, be construed as limited to the particular form described as it is to be regarded as illustrative rather than restrictive. Variations and changes may be made by those skilled in the art without departing from the scope and spirit of the invention as set forth in the appended claims.

What is claimed is:

1. A plug for a fluid system, the plug comprising: i) a body with an external retention device and a head at one end of the body; the plug including an internal main cavity with a) a first fluid passage into the main cavity from another end of the body, and b) at least one second passage into the main cavity fluidly separate from the first passage; and ii) a piston retained within the main cavity and normally blocking fluid flow from the first passage to the second passage, and having a geometry and configuration such that a shear portion of the piston will rupture and separate from the remainder of the piston at a predetermined pressure differential across the first and second passages, and allow fluid to flow from the first passage to the second passage.

2. The plug as in claim 1, wherein the at least one second fluid passage has a geometry smaller than the shear portion of the piston.

3. The plug as in claim 2, wherein the at least one second fluid passage is a generally radial passage through the plug.

4. The plug as in claim 2, wherein the at least one second passage is an axial passage in the plug head.

5. The plug as in claim 1, wherein the body is externally threaded.

6. The plug as in claim 1, wherein the head is an enlarged head, which is radially larger than the body.

7. The plug as in claim 1, wherein the piston includes an end wall with a relatively thin portion, the thin portion of the end wall defining the shear portion of the piston.

8. The plug as in claim 1, wherein the piston includes an end wall, the end wall including a score line defining the shear portion.

9. The plug as in claim 1, wherein the piston is sealingly and fixedly retained within an enlarged cavity portion of the main cavity of the body.

10. The plug as in claim 9, wherein the piston is supported against an internal radial shoulder in the main cavity.

11. The plug as in claim 10, wherein the opening of the first fluid passage at the other end of the body is mechanically formed over an outer end of the piston to retain the piston within the main cavity.

12. The plug as in claim 9, further including an O-seal between an exterior wall of the piston and an inner wall surface of the body.

13. An over-pressure relief device for a fluid system, the device comprising: i) a body and a head at one end of the body; the device including an internal cavity with a) a first fluid passage into the cavity from another end of the body, and b) at least one relief passage from the cavity fluidly separate from the first passage; and ii) a burst wall within the cavity and normally blocking fluid flow from the first passage to the relief passage, and having a geometry and configuration such that a shear portion of the wall will rupture and separate from the remainder of the wall at a predetermined pressure differential across the first and relief passages, and allow fluid to flow from the first passage to the relief passage, the relief passage having a geometry such that the separated portion cannot pass through the relief passage.

14. The device as in claim 13, wherein the body is externally threaded.

15. The device as in claim 13, wherein the wall includes a relatively thin portion compared to a surrounding portion, the thin portion defining the shear portion.

16. The device as in claim 13, wherein the wall includes a score line defining the shear portion.
